(19) United States
(12) Patent Application Publication
(10) Pub. No.: US 2026/0310681 A1
(43) Pub. Date: Oct. 8, 2026

(54) Centralized Multi-Source Incident Data Clearinghouse Architecture for Incident Intelligence and Cross-System Event Correlation

(71) Applicant: Myron S. Herron, JR., Greensboro, NC (US)

(72) Inventor: Myron S. Herron, JR., Greensboro, NC (US)

(21) Appl. No.: 19/636,039

(22) Filed: Apr. 1, 2026

Related U.S. Application Data
(60) Provisional application No. 63/783,350, filed on Apr. 4, 2025.

(51) Int. Cl. G06F 16/25; G06F 16/21; G06F 16/27

(52) U.S. Cl. CPC G06F 16/258; G06F 16/211; G06F 16/27

(57) ABSTRACT

A centralized multi-source incident data clearinghouse receives heterogeneous incident data from public safety and non-emergency service systems, normalizes and correlates the data into unified incident profiles independent of any individual source, distributes enriched structured outputs via a shared integration layer that abstracts direct point-to-point integrations, reduces duplicated computation and latency, and incorporates operational outcome feedback into adaptive machine-learning refinement without performing call routing.

Your petitioner, Myron S. Herron, Jr., a citizen of the United States, whose address is 1307 Westminster Drive, Greensboro, North Carolina 27410, prays that Letters Patent may be granted to him for improvements in a Centralized Multi-Source Incident Data Clearinghouse Architecture for Incident Intelligence and Cross-System Event Correlation as set forth in the following specification.

This non-provisional patent application claims all benefits under 35 U.S.C. § 119(e) of pending U.S. provisional patent application Ser. No. 63/783,350 filed 4 Apr. 2025, entitled “Public Safety Data Clearinghouse Method and System with Bidirectional Feedback Loops”, in the United States Patent and Trademark Office, which is incorporated by reference in its entirety herein.

### FIELD OF THE INVENTION

The present disclosure relates generally to distributed computing systems and data processing architectures for aggregating, normalizing, correlating, enriching, and distributing heterogeneous incident-related data originating from human-initiated communication systems and non-human-initiated machine-generated systems across public and private operational environments.

### DESCRIPTION OF THE PRIOR ART AND OBJECTIVES OF THE INVENTION

Modern operational ecosystems including emergency response systems, crisis support networks, transportation information systems, healthcare triage systems, enterprise service platforms, and other event-driven environments generate large volumes of heterogeneous incident-related data from diverse ingress sources.

Such sources may include traditional 9-1-1 systems, Next Generation 9-1-1 (NG9-1-1) systems, 988 crisis response systems, 411 directory services, 511 travel information systems, toll-free service platforms, Internet of Things (IoT) sensor networks, telematics systems, video analytics platforms, alarm systems, and environmental monitoring systems.

As used herein, “Next Generation 9-1-1” (NG9-1-1 or NG911) refers to Internet Protocol (IP)-based emergency communications systems that enable the transmission of voice, text, video, sensor data, and other multimedia communications from the public to emergency services through packet-switched networks. NG9-1-1 architectures may include emergency services IP networks (ESInets), emergency services routing proxies (ESRPs), and related call handling infrastructure supporting the delivery and processing of emergency communications.

The systems and methods described herein are not limited to NG9-1-1 environments and may be applied to other operational ecosystems that generate heterogeneous incident-related data.

Although described primarily in public-safety and emergency-response contexts, the disclosed architecture may be adaptable to other incident-processing environments.

As used herein, “Internet of Things” (IoT) refers to networks of physical devices, sensors, vehicles, appliances, infrastructure systems, and other equipment capable of collecting and transmitting data through wired or wireless communication networks. IoT systems may include sensor arrays, environmental monitoring devices, connected infrastructure, telematics systems, and other machine-generated event sources capable of automatically generating data relating to physical-world conditions or events.

Conventional system architectures typically require direct point-to-point integration between each ingress source and each downstream operational system. As the number of sources and recipient systems increases, the integration model scales non-linearly, resulting in an N-to-N integration architecture that increases computational duplication, latency, maintenance burden, inconsistent data interpretation, and overall system complexity.

Each additional ingress source or recipient system increases the number of required integration pathways and further amplifies architectural complexity.

In such architectures, normalization, correlation, enrichment, and prioritization functions are frequently implemented redundantly across multiple systems without a shared canonical schema governing cross-system incident representation. This redundancy increases computational load and can produce inconsistent operational outcomes across connected systems.

Existing routing-focused infrastructures primarily emphasize communication delivery rather than structured data abstraction, cross-source incident correlation, unified incident modeling, or adaptive predictive refinement.

Accordingly, existing incident-processing systems lack a shared incident intelligence layer capable of synthesizing heterogeneous incident-related data across multiple operational systems. Various other objectives and advantages of the present disclosure will become apparent to those skilled in the art as a more detailed description is set forth below.

### SUMMARY OF THE INVENTION

The aforesaid and other objectives are realized by providing a centralized data clearinghouse system that logically centralizes normalization, correlation, enrichment, structured abstraction, and adaptive model refinement across heterogeneous ingress sources.

The centralized data clearinghouse system receives heterogeneous incident data from multiple ingress systems, transforms the data into protocol-independent structured representations, correlates attributes across sources to construct unified incident profiles independent of any individual ingress source, and distributes enriched structured outputs through a shared integration layer that abstracts direct source-to-destination coupling.

By performing normalization and correlation once within a logically centralized processing layer and distributing structured outputs to multiple downstream systems, the architecture reduces duplicated computation, reduces latency, reduces integration complexity from an N-to-N architecture to a centralized intermediary architecture, and reduces computational load on recipient systems.

The centralized data clearinghouse system processes and enriches data associated with incidents but does not perform call routing. Routing decisions may instead be performed independently by downstream systems that consume structured outputs generated by the clearinghouse.

The architecture described herein constitutes a technical improvement to distributed computing systems by centralizing normalization, correlation, and enrichment functions that would otherwise be redundantly implemented across multiple downstream systems. By abstracting heterogeneous ingress protocols into a canonical internal representation and performing correlation once prior to structured distribution, the system reduces duplicated computational processing, reduces latency associated with repeated data transformation, and improves scalability of distributed operational environments. Accordingly, the disclosure improves the functioning of computer systems themselves rather than merely organizing information.

### BRIEF DESCRIPTION OF THE DRAWINGS

FIG. 1 shows a system architecture of a centralized incident data clearinghouse according to an embodiment of the present disclosure.

FIG. 2 pictures a processing workflow executed by the centralized data clearinghouse system according to an embodiment of the present disclosure.

FIG. 3 depicts a unified incident profile structure generated by the centralized data clearinghouse system according to an aspect of the present disclosure.

FIG. 4 demonstrates an AI model training and refinement architecture associated with the centralized data clearinghouse system according to an embodiment of the present disclosure.

FIG. 5 illustrates an interaction architecture between the centralized data clearinghouse system and multiple external systems according to an aspect of the present disclosure.

### DETAILED DESCRIPTION OF THE PREFERRED EMBODIMENT AND OPERATION OF THE INVENTION

Various exemplary embodiments of the present disclosure are described below. Use of the term “exemplary” means illustrative or by way of example only, and any reference herein to “the disclosure” is not intended to restrict or limit the disclosure to exact features or step of any one or more of the exemplary embodiments disclosed in the present specification. References to “exemplary embodiment”, “one embodiment”, “an embodiment”, “various embodiments”, and the like may indicate that the embodiment(s) of the disclosure so described may include a particular feature, structure, or characteristic, but not every embodiment necessarily incudes the particular feature, structure, or characteristic. Further, repeated use of the phrase “in one embodiment”, “in an exemplary embodiment”, or “in an alternative embodiment” do not necessarily refer to the same embodiment, although they may.

It is also noted that terms like “preferably”, “commonly”, and “typically” are not utilized herein to limit the scope of the disclosure or to imply that certain features are critical, essential, or even important to the structure or function of the disclosure. Rather, these terms are merely intended to highlight alternative or additional features that may or may not be utilized in a particular embodiment of the present disclosure.

The present disclosure is described more fully hereinafter with reference to the accompanying figures, in which one or more exemplary embodiments of the disclosure are shown. Like numbers used herein refer to like elements throughout. The disclosure may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limited as to the scope of the disclosure, and any and all equivalents thereof. Moreover, many embodiments such as adaptations, variations, modifications, and equivalent arrangements will be implicitly disclosed by the embodiments described herein and fall within the scope of the instant disclosure.

Although specific terms are employed herein, they are used in a generic and descriptive sense only and not for the purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. Where only one item is intended, the terms “one and only one”, “single”, or similar language is used. When used herein to join a list of items, the term “or” denotes at least one of the items but does not exclude a plurality of items of the list.

For exemplary methods or processes of the disclosure, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present disclosure.

Additionally, any references to advantages, benefits, unexpected results, or operability of the present disclosure are not intended as an affirmation that the disclosure has previously been reduced to practice or that any testing has been performed. Likewise, unless stated otherwise, use of verbs in the past tense (present perfect or preterit) is not intended to indicate or imply that the disclosure has previously been reduced to practice or that any testing has been performed.

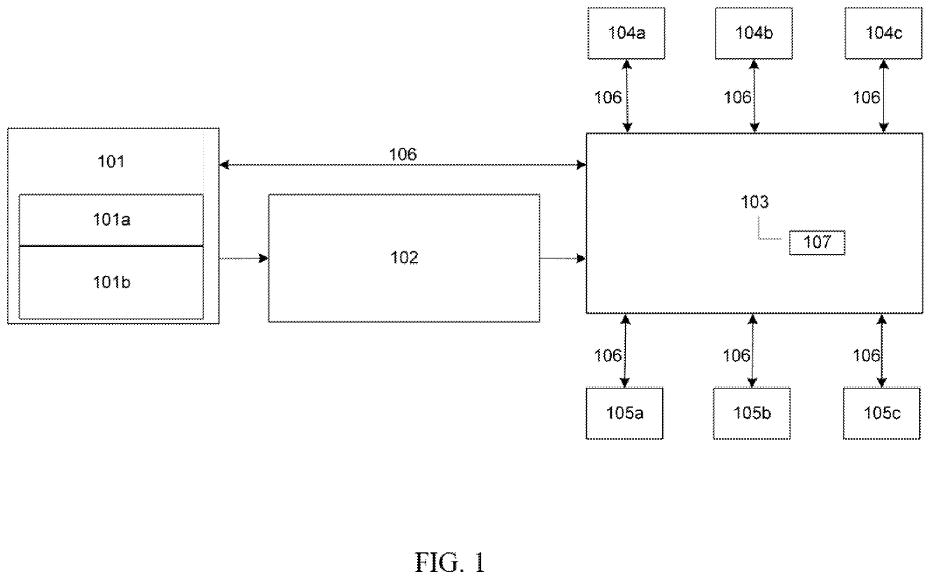

For a better understanding of the disclosure and its operation, turning now to the drawings, FIG. 1 depicts the preferred embodiment of a system architecture 100 including heterogeneous ingress sources 101, an optional preprocessing layer 102, a centralized data clearinghouse system 103, downstream operational systems 104, responder and field systems 105, and bidirectional feedback pathways 106 is illustrated.

Ingress sources 101 may include both human-initiated systems and non-human-initiated machine-generated systems. Human-initiated sources may include telephony systems, Next Generation 9-1-1 (NG911) systems, 988 crisis service platforms, directory assistance platforms, mobile applications, and web-based service platforms. Non-human-initiated sources may include telematics systems, crash detection systems, Internet-of-Things (IoT) sensors, alarm systems, video analytics platforms, environmental monitoring systems, and other automated detection systems. The system architecture is not limited to any specific ingress communication protocol, data format, or signaling interface.

FIG. 1 further illustrates that ingress sources 101 may include multiple systems, illustrated for example as human-initiated data sources 101a and non-human-initiated sources 101b. These elements represent categories of ingress systems capable of generating heterogeneous incident-related data.

Element 102 represents one or more preprocessing or edge processing components configured to receive heterogeneous data from ingress sources 101 and transmit the data to the centralized data clearinghouse system 103. In some implementations, preprocessing may include preliminary filtering, protocol translation, edge analytics, or data validation prior to delivery to the centralized processing environment.

The centralized data clearinghouse system 103 represents a logically centralized processing environment configured to receive heterogeneous data from ingress sources 101. The clearinghouse system 103 performs data normalization, correlation across multiple sources, enrichment of received data, construction of unified incident representations, and distribution of structured outputs to downstream systems. Logical centralization does not require physical centralization, and the clearinghouse system 103 may be implemented across multiple distributed processing nodes operating as a coordinated processing layer.

In certain embodiments, the centralized data clearinghouse system 103 includes an incident intelligence processing layer 107 configured to perform normalization, correlation, unified incident profile construction, and structured distribution. The incident intelligence processing layer 107 represents processor-executed logic responsible for transforming heterogeneous ingress data into canonical structured representations suitable for multi-system consumption.

The centralized data clearinghouse system 103 is architecturally positioned between the ingress sources 101 and downstream systems such that heterogeneous ingress data is processed through canonical transformation and correlation functions prior to distribution of structured outputs.

The centralized data clearinghouse operates independently of telephony routing, call switching, and communication transport infrastructure. Rather than performing call routing or message switching, the clearinghouse operates at a data abstraction and incident intelligence layer.

FIG. 1 further illustrates downstream operational systems 104a-104c, which represent example emergency communication centers or other operational environments capable of receiving structured outputs generated by the centralized data clearinghouse system 103. Although three such systems are illustrated for clarity, any number of downstream operational systems may be connected to the clearinghouse architecture.

FIG. 1 additionally illustrates responder or field systems 105a-105c. These systems may include emergency responders, drones or robotic systems, emergency vehicles, mobile command centers, or other operational platforms capable of receiving incident intelligence produced by the centralized data clearinghouse system 103.

Structured outputs generated by the centralized data clearinghouse system 103 may be transmitted to both operational systems 104 and responder systems 105. In certain embodiments, these systems may also transmit operational feedback to the centralized data clearinghouse.

Bidirectional pathways 106 represent feedback paths between participating systems and the centralized data clearinghouse system 103. Feedback may include operational outcome data, response timing data, disposition codes, validation updates, correction signals, or other operational information. Such feedback may be used to refine correlation logic, predictive analytics, and system-level optimization processes performed by the centralized data clearinghouse.

FIG. 1 further illustrates that a single ingress source 101 may contribute data used to generate structured outputs consumed by multiple downstream systems, and that multiple ingress sources 101 may contribute data to a unified incident representation produced by the centralized data clearinghouse system 103.

The centralized data clearinghouse system functions as a shared incident intelligence layer that synthesizes heterogeneous incident data into canonical incident representations usable across multiple operational systems.

### Technical Advantage

This architecture improves interoperability and scalability of heterogeneous incident-processing systems by introducing a centralized data clearinghouse that performs protocol-independent normalization, multi-source correlation, and unified incident profile construction once prior to distribution, thereby eliminating the need for direct bilateral integrations between ingress sources and downstream operational systems.

The disclosed architecture improves computer system operation by reducing redundant correlation and protocol transformation computations. The centralized architecture described herein constitutes an improvement to the functioning of distributed computer systems. By performing protocol transformation, correlation, and structured enrichment once within a logically centralized processing layer prior to downstream distribution, the system reduces redundant computational operations, decreases network load, and minimizes latency relative to bilateral integration architectures. The improvement resides in the structural reconfiguration of distributed data exchange topology rather than in the mere automation of human activity.

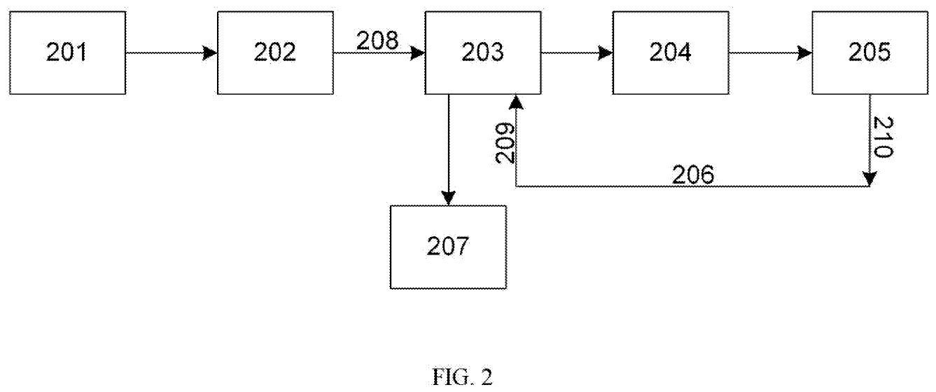

Referring to FIG. 2, a processing workflow 200 executed by the centralized data clearinghouse system is illustrated. Processing workflow 200 may be executed within the incident intelligence processing layer 107 of the centralized data clearinghouse 103. The numbered elements of FIG. 2 represent logical processing components and data flows within the centralized clearinghouse architecture. Whereas FIG. 1 illustrates the structural system architecture, FIG. 2 illustrates operational data processing flows occurring within the centralized clearinghouse architecture.

Processing workflow 200 illustrates example operations performed by the centralized data clearinghouse 103 when generating unified incident profiles from heterogeneous ingress data. Element 201 represents ingress data received from heterogeneous sources and transmitted to normalization module 202. Normalization module 202 transforms heterogeneous ingress formats into a canonical internal schema stored in structured memory. Schema transformation may include protocol conversion, field mapping, timestamp harmonization, geospatial normalization, and validation routines.

Normalized data is transmitted to correlation engine 203. Correlation engine 203 performs temporal clustering, geospatial proximity analysis, probabilistic entity resolution, and metadata reconciliation. Entity resolution may include similarity scoring, confidence weighting, and conflict reconciliation. Correlation and enrichment occur once within the centralized clearinghouse prior to distribution to downstream systems.

Correlated data is used to construct unified incident profile 204. Unified incident profile 204 aggregates attributes across sources into a structured representation independent of any individual ingress protocol.

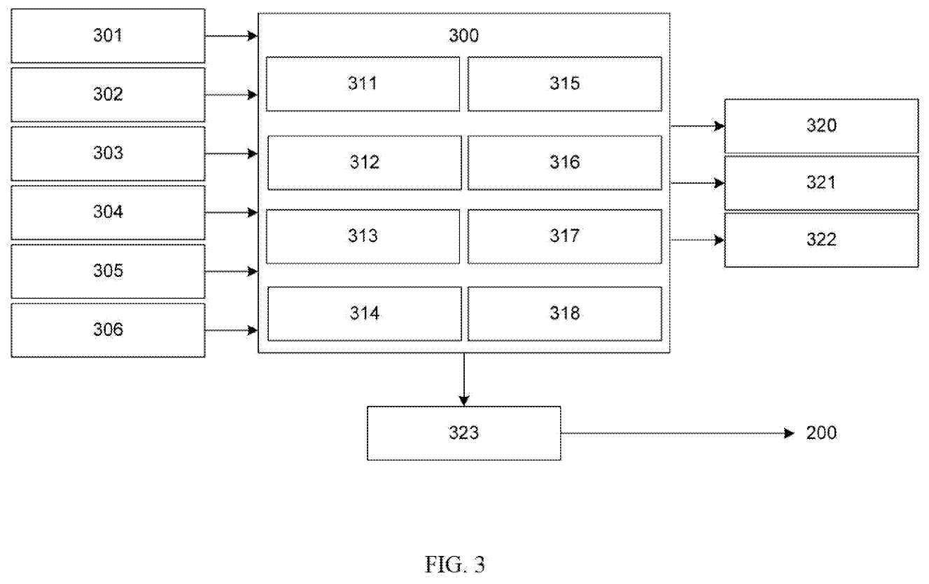

Unified incident profile 204 of FIG. 2 corresponds to unified incident profile structure 300 illustrated in FIG. 3, which depicts the structured internal representation generated by the centralized data clearinghouse system.

Element 205 represents structured outputs generated from the unified incident profile and transmitted to downstream operational systems. Distribution may occur through application programming interfaces (APIs), event streams, message queues, publish-subscribe interfaces, or other processor-executed distribution mechanisms.

Element 206 represents operational feedback transmitted from downstream systems back to the centralized data clearinghouse system. Such feedback may influence future correlation weighting, prioritization logic, or model refinement operations. Operational feedback 206 of FIG. 2 corresponds to operational feedback pathway 106 illustrated in FIG. 1.

By performing normalization, correlation, and canonical schema transformation once within the centralized clearinghouse architecture, workflow 200 reduces duplicated computation and reduces integration complexity relative to distributed N-to-N architectures. Downstream systems interact with structured outputs generated from the canonical schema representation rather than directly integrating with heterogeneous ingress protocols.

Workflow 200 further includes additional functional effects and data flows illustrated in FIG. 2. Element 207 represents aggregated and curated data generated by the centralized clearinghouse following correlation and unified profile construction. Element 208 represents protocol-independent transformation enabling distribution of structured outputs across heterogeneous downstream systems. Element 209 represents refinement feedback information used to improve correlation weighting, prioritization logic, or model refinement processes.

Element 210 represents the resulting unified incident representation made available to authorized systems for downstream operational consumption. Unified incident representation 210 corresponds to the unified incident profile structure illustrated in FIG. 3, which provides a detailed representation of the correlated multi-source incident data generated by the centralized data clearinghouse system.

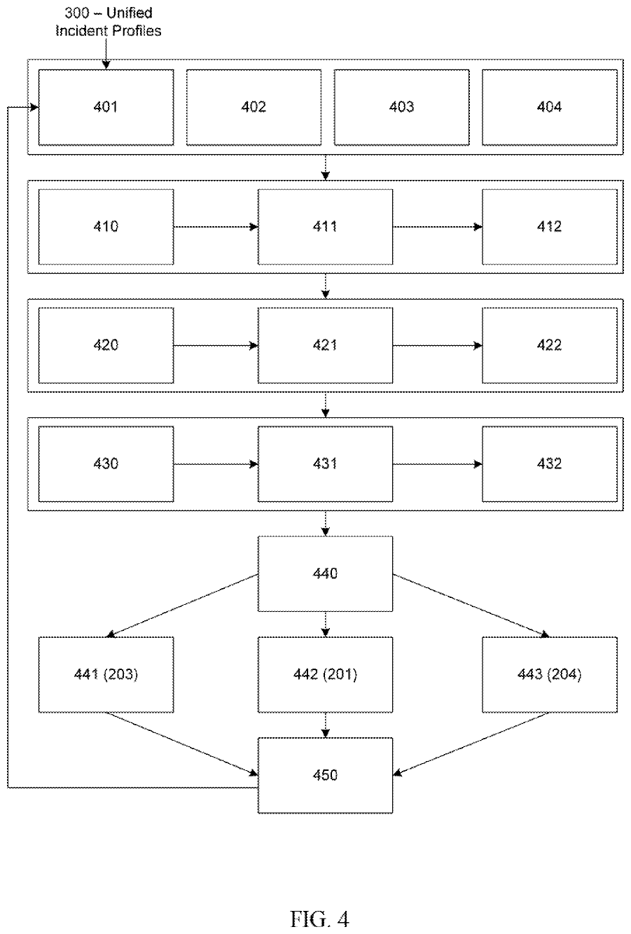

In some embodiments, the incident processing environment 200 may utilize predictive models generated by the model training architecture described with reference to FIG. 4. Such predictive models may be trained using structured incident data derived from unified incident profiles generated by the centralized data clearinghouse system described with reference to FIG. 3. Referring to FIG. 3, an illustrative structure of a unified incident profile 300 generated by the centralized data clearinghouse system is shown.

Multiple heterogeneous ingress data categories 301-306 may contribute information used to construct unified incident profile 300. These ingress data categories may include, for example:
301—telephony and communication data originating from wireline, wireless, VoIP, or other communication systems;
302—sensor and Internet-of-Things (IoT) event data generated by connected devices, environmental monitoring systems, or infrastructure sensors;
303—video and analytics data derived from surveillance systems, computer-vision systems, or automated anomaly detection systems;
304—operational updates generated by Emergency Communications Centers (ECCs) or other operational command systems;
305—responder field data generated by first responder devices, mobile applications, vehicle telemetry systems, or field reporting tools; and
306—external data feeds obtained from third-party information sources including weather services, traffic systems, infrastructure monitoring platforms, or other external intelligence sources.

The ingress data categories illustrated as elements 301-306 represent non-limiting examples of heterogeneous incident-related data sources. Additional ingress data categories, communication systems, sensor platforms, or machine-generated event sources may also contribute information to unified incident profile 300 without departing from the scope of the disclosed architecture.

Data received from one or more of ingress categories 301-306 is normalized and correlated by the centralized data clearinghouse system to construct unified incident profile 300. Unified incident profile 300 represents a structured, protocol-independent incident representation generated using the canonical internal schema described throughout this disclosure.

Unified incident profile 300 may include a plurality of structured incident attributes 311-318, which collectively represent the normalized and correlated incident information. In some embodiments, these attributes may include:
311—Event Identifier, representing a unique identifier associated with the incident;
312—Temporal Metadata, representing time-related attributes such as event time, reporting time, update timestamps, or temporal correlation data;
313—Geospatial Metadata, representing location information including coordinates, address data, geographic regions, or spatial correlation attributes;
314—Correlated Entity Relationships, representing relationships among entities associated with the incident including persons, vehicles, devices, locations, or infrastructure components;
315—Source Provenance Metadata, representing the origin, source reliability, and attribution of information associated with the incident;
316—Confidence Metrics, representing confidence scores, weighting factors, or probabilistic assessments associated with correlated incident data;
317—Contextual Enrichment, representing contextual information derived from data correlation, external intelligence sources, or system-generated enrichment processes; and
318—Predictive Outputs, representing predictive indicators, classifications, or analytic outputs generated by predictive models operating within the centralized data clearinghouse system.

Unified incident profile 300 may be distributed to multiple downstream operational systems. In the illustrated embodiment, structured outputs derived from unified incident profile 300 may be provided to:
320—ECC interface outputs, which may provide incident information to emergency communications center systems;
321—responder interface outputs, which may provide incident information to responder devices, mobile systems, or field-operational tools; and
322—authorized application outputs, which may provide incident information to approved third-party applications or operational systems.

In addition to operational distribution, unified incident profile 300 may also provide structured training data for predictive model development. As illustrated in FIG. 3, data derived from unified incident profile 300 may be provided to model-training input 323, which supplies structured incident data to the model training architecture illustrated in FIG. 4.

Predictive models generated using the training architecture may subsequently be deployed for use within incident processing operations 200 described with reference to FIG. 2. In this manner, unified incident profiles generated during runtime processing may contribute to ongoing predictive model refinement, while updated predictive models may influence future incident processing and analysis. Referring to FIG. 4, an illustrative architecture of a model training and evaluation pipeline used by the centralized data clearinghouse system is shown.

In some embodiments, the training pipeline may utilize unified incident profiles 300, generated as described with reference to FIG. 3, as structured training inputs for predictive model development. Unified incident profiles 300 may be received by an initial data preparation stage 401-404. In this stage, training data may be prepared and conditioned for use by machine-learning pipelines. In some embodiments:
401 may represent a data ingestion or dataset assembly component configured to receive unified incident profiles and prepare training datasets;
402 may represent a data normalization or transformation component configured to standardize incident data attributes into formats suitable for machine learning;
403 may represent a feature extraction component configured to derive structured features from the incident profiles; and
404 may represent a dataset partitioning component configured to generate training, validation, and testing datasets.

Prepared datasets may then be provided to a model training stage 410-412. In some embodiments:
410 may represent a training data loader or batch preparation module configured to supply training examples to a model training process;
411 may represent a machine-learning training engine configured to train predictive models using the prepared datasets; and
412 may represent a trained model artifact generated as the output of the training process.

The trained model artifact may then proceed to a model evaluation stage 420-422. In some embodiments:
420 may represent an evaluation dataset loader configured to provide validation or testing datasets;
421 may represent a model evaluation engine configured to assess model performance using defined evaluation metrics; and
422 may represent an evaluation output module configured to generate model performance metrics, validation results, or comparative evaluation reports.

Following evaluation, model artifacts may proceed to a model validation stage 430-432. In some embodiments:
430 may represent validation policies or acceptance criteria defining minimum performance thresholds or operational constraints;
431 may represent a validation engine configured to compare evaluation outputs against the defined criteria; and
432 may represent a validation result indicating whether the trained model satisfies operational deployment requirements.

If validation criteria are satisfied, the model artifact may proceed to a model packaging and distribution component 440, which may prepare the trained model for deployment to operational environments.

Packaged models may then be distributed to multiple operational systems. In the illustrated embodiment, deployment targets 441-443 represent operational processing environments within the incident processing workflow illustrated in FIG. 2, including components responsible for incident ingestion, correlation, and predictive analysis.

These deployment targets may represent different operational environments within the incident processing architecture in which trained predictive models are applied during incident processing. Operational performance data associated with deployed models may subsequently be collected by a feedback and monitoring component 450. The feedback component may collect operational outcome data, performance telemetry, or other feedback information associated with model performance in operational environments.

Feedback collected by component 450 may be returned to the training pipeline, as illustrated by the feedback path returning to 401, enabling continuous improvement of predictive models through iterative retraining using updated incident data and operational performance outcomes. In this manner, the architecture illustrated in FIG. 4 enables a continuous learning pipeline in which unified incident data generated by the centralized clearinghouse system may be used to train predictive models that are subsequently deployed within the incident processing environment described with reference to FIG. 2, while operational feedback may be used to further refine future model training cycles.

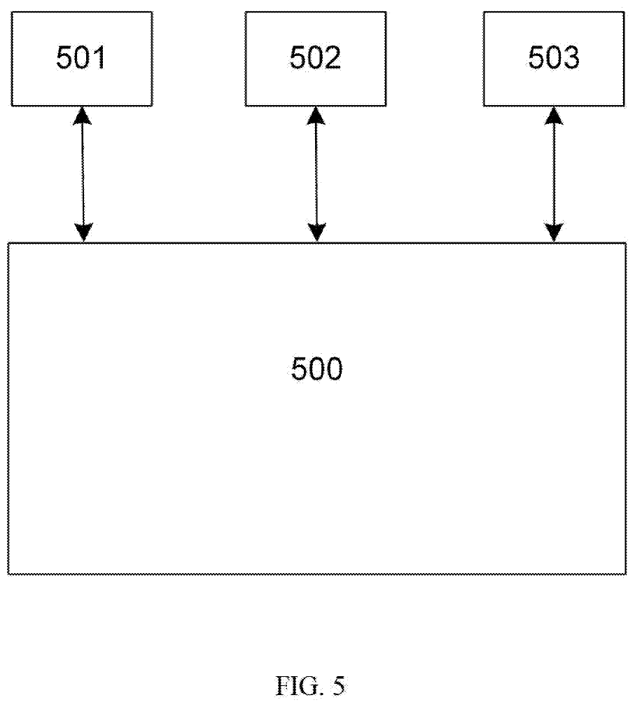

In certain embodiments, the centralized data clearinghouse system may store unified incident profiles and associated metadata in persistent storage for use in ongoing model training, performance evaluation, audit tracing, and continuous refinement of predictive models. Referring to FIG. 5, an illustrative interaction architecture is shown in which the centralized data clearinghouse system exchanges incident-related information with multiple external systems.

In some embodiments, a centralized clearinghouse component 500 may operate as an intermediary system configured to exchange structured incident information with multiple external systems. The centralized clearinghouse 500 may maintain the canonical internal schema described throughout this disclosure and may provide a standardized interface through which heterogeneous external systems may exchange incident-related data.

External systems 501, 502, and 503 may represent independent operational systems capable of interacting with the centralized clearinghouse 500. These external systems may include, for example, emergency communications center systems, responder systems, analytics platforms, data providers, or authorized third-party applications. The illustrated systems are provided for explanatory purposes and should not be interpreted as limiting the number or type of systems capable of interacting with the clearinghouse.

As illustrated in FIG. 5, bidirectional communication paths may exist between the centralized clearinghouse 500 and each of the external systems 501, 502, and 503. Through these bidirectional communication interfaces, the clearinghouse 500 may receive incident-related information from the external systems and may also distribute normalized or enriched incident information to those systems. In some embodiments, external systems 501-503 may provide heterogeneous incident data to the clearinghouse 500, which may then transform the received data into structured representations conforming to the canonical internal schema. The clearinghouse 500 may further correlate, enrich, or analyze the received information as described with reference to FIGS. 3 and 4.

The clearinghouse 500 may subsequently distribute structured outputs, enriched incident data, or predictive insights back to one or more of the external systems 501-503. This bidirectional interaction architecture enables the centralized clearinghouse 500 to function as an intermediary data exchange layer that reduces direct system-to-system integrations between external platforms.

In this manner, the architecture illustrated in FIG. 5 enables multiple heterogeneous systems to exchange incident-related information through the centralized clearinghouse 500, while maintaining a consistent canonical data model and allowing the clearinghouse to perform data normalization, correlation, enrichment, and predictive processing prior to redistributing information to participating systems.

### General Architecture Explanation

The centralized data clearinghouse system may be implemented using one or more processors, non-transitory memory, and network interfaces executing instructions configured to perform normalization, correlation, integration abstraction, unified incident profile construction, and adaptive model refinement.

The architecture described herein represents a technical improvement to distributed computing systems by centralizing heterogeneous protocol normalization, cross-source correlation, and structured incident profile generation within a shared processing infrastructure that reduces redundant computation and integration complexity across connected systems.

As used herein, the term “centralized” refers to logical centralization of normalization and correlation functions. Such logical centralization does not require physical centralization, and the system may be implemented across distributed computing resources including cloud-native environments, hybrid edge-cloud systems, fog computing nodes, clustered infrastructure, or other distributed processing environments operating as a coordinated processing layer.

The centralized data clearinghouse system operates at a data abstraction and intelligence layer that is logically distinct from communication transport or call routing infrastructure. While ingress data may originate from telephony systems, IP-based communication networks, or other transport mechanisms, the clearinghouse does not control call routing, message switching, or transport-layer delivery functions. Instead, the system processes structured data derived from such systems and generates enriched incident representations for downstream consumption. This architectural separation reinforces that the disclosure improves data processing architecture independently of transport-layer technologies.

The normalization, correlation, shared integration, unified incident profile construction, and model refinement mechanisms described herein represent non-limiting implementation examples of the centralized data clearinghouse architecture described throughout this specification. These implementations illustrate operational embodiments of the disclosed architecture and do not limit the scope of the invention. Normalization transforms heterogeneous ingress formats into a canonical internal schema stored in non-transitory memory accessible to one or more processors of the centralized data clearinghouse system. Schema mapping may convert XML, JSON, streaming payloads, telephony metadata, sensor telemetry, and proprietary data formats into standardized internal field structures. Timestamp harmonization converts disparate time representations into a unified temporal reference, while geospatial normalization converts coordinate systems into a consistent geographic reference system. Validation logic may verify required fields and apply correction, enrichment, or rejection policies.

The canonical internal schema enables protocol-independent correlation and downstream distribution of structured incident representations. The canonical internal schema provides a protocol-independent data abstraction layer that allows heterogeneous ingress systems to contribute incident data without requiring downstream systems to implement protocol-specific integration logic. Because normalization and correlation occur within the centralized clearinghouse prior to distribution, downstream systems consume unified incident representations without performing independent protocol translation or cross-source correlation.

A correlation engine may execute temporal clustering algorithms that group event attributes within defined time thresholds and perform geospatial proximity analysis to associate events occurring within configurable spatial boundaries. Probabilistic entity resolution may apply confidence weighting, similarity scoring, and metadata reconciliation to merge duplicate or conflicting records. Correlation and enrichment operations occur once within the centralized clearinghouse prior to distribution of structured outputs, thereby reducing redundant processing across recipient systems.

The correlation operations performed by the centralized data clearinghouse system are not limited to data aggregation or presentation. Rather, the system performs structured entity resolution, probabilistic weighting, and conflict reconciliation using processor-executed transformation logic operating on canonical schema representations stored in non-transitory memory. The resulting unified incident profile constitutes a computer-generated structured representation that does not exist within any individual ingress source.

The shared integration layer may implement a publish-subscribe architecture in which ingress systems register once with the centralized interface while downstream systems subscribe to structured outputs via standardized APIs, event streams, or messaging interfaces. Because ingress heterogeneity is abstracted by the clearinghouse architecture, recipient systems are not required to modify internal workflows or process logic. By replacing direct bilateral integrations with centralized abstraction, integration complexity may be reduced from an N-to-N architecture to a centralized intermediary architecture, thereby reducing maintenance overhead and computational duplication.

A unified incident profile aggregates correlated multi-source data into a structured representation independent of any individual ingress source. Such profiles may include identifiers, temporal metadata, geospatial metadata, correlated entity relationships, confidence scores, priority classifications, predictive indicators, contextual enrichment attributes, and provenance metadata.

Unified incident profiles may support cross-jurisdiction data fusion and cross-domain model refinement across multiple operational domains including emergency response, crisis support services, transportation systems, and enterprise environments. Feature extraction modules may convert unified incident profiles into structured feature vectors suitable for machine learning processes. An inference engine may execute predictive models during real-time processing to generate prioritization outputs and risk classifications.

Operational feedback may include outcome data, response timing data, disposition codes, and downstream decision results. Drift detection logic may compare current performance metrics against historical baselines and trigger model retraining when deviation thresholds are exceeded. Updated model parameters may be deployed to inference components while preserving version control and audit history. Operational system-level feedback is logically distinct from model-training feedback, and the architecture maintains separation between runtime inference operations and offline training updates.

The centralized data clearinghouse system may implement encryption in transit and at rest, role-based access control, multi-factor authentication, audit logging, and policy-based data segmentation. The system may support compliance with regulatory frameworks including CJIS, HIPAA, and NENA i3 without limiting the scope of the disclosure to any specific regulatory regime. In certain embodiments, the centralized data clearinghouse system may be implemented using redundant processing nodes, replicated data stores, and failover clustering to provide high-availability operation. Because logical centralization does not require a single physical server, the architecture may include distributed processing instances operating in coordinated fashion to ensure continuity of service during hardware failure, network interruption, or maintenance events. Such redundancy mechanisms further distinguish the disclosure as an improvement in distributed computing resilience and operational reliability.

In certain embodiments, the centralized data clearinghouse system improves the functioning of distributed computer systems by restructuring how heterogeneous incident data is normalized, correlated, and distributed across multiple operational domains. Rather than requiring each recipient system to independently process heterogeneous ingress protocols and perform redundant correlation operations, the centralized data clearinghouse performs protocol-independent normalization and cross-source correlation once and distributes unified incident representations to multiple downstream systems. This architectural restructuring reduces duplicated computation, decreases network overhead, and improves scalability, latency, and operational efficiency of distributed computer systems interacting with heterogeneous data sources.

The centralized data clearinghouse system therefore performs processor-executed transformations on heterogeneous machine-generated data to produce structured incident representations that did not previously exist within any individual ingress system, thereby improving the operation of distributed computer systems that process incident-related data.

The illustrations and examples provided herein are for explanatory purposes and are not intended to limit the scope of the appended claims. Variations in components, ordering, or implementation may be made without departing from the scope of the disclosure.

I claim:

1. A computer-implemented method executed by one or more processors of a centralized data clearinghouse system for processing heterogeneous incident data across multiple operational systems, the system including non-transitory memory storing a canonical internal schema, the method comprising:
receiving heterogeneous incident data from multiple ingress sources;
transforming the heterogeneous incident data into protocol-independent structured representations conforming to the canonical internal schema stored in the non-transitory memory of the centralized data clearinghouse system;
correlating, within the centralized data clearinghouse system operating as a logically centralized processing layer across distributed computing resources, attributes across the multiple ingress sources to construct and store a unified incident profile represented in the canonical internal schema and independent of any individual ingress protocol;
performing the correlating once to generate the unified incident profile prior to distribution to multiple downstream operational systems;
distributing enriched structured outputs derived from the unified incident profile through a shared integration layer that abstracts direct bilateral source-to-destination integrations between the ingress sources and the downstream systems; and
updating one or more predictive machine-learning models based on operational outcome feedback received from one or more of the downstream systems.

2. The method of claim 1, wherein the shared integration layer reduces integration complexity from an N-to-N architecture to a centralized intermediary architecture.

3. The method of claim 1, wherein transforming the heterogeneous incident data comprises converting heterogeneous ingress protocols into a canonical internal schema stored in a non-transitory memory of the centralized data clearinghouse system.

4. The method of claim 1, wherein correlating includes applying probabilistic entity resolution with confidence weighting to reconcile conflicting or duplicate records.

5. The method of claim 1, wherein updating predictive models includes triggering retraining when detected performance drift exceeds a defined deviation threshold.

6. The method of claim 1, wherein correlation and enrichment are performed once within the centralized data clearinghouse system prior to distribution to multiple downstream systems.

7. The method of claim 1, wherein the unified incident profile supports cross-jurisdiction model refinement across multiple operational domains.

8. The method of claim 1, wherein the unified incident profile constitutes a canonical incident representation reusable across multiple downstream operational systems.

9. The method of claim 1, wherein the unified incident profile is reused for distribution to multiple downstream systems without re-performing correlation.

10. The method of claim 1, wherein the unified incident profile is stored in the canonical internal schema in non-transitory memory for reuse by multiple downstream operational systems.

11. The method of claim 1, wherein predictive model training utilizes unified incident profiles constructed from correlated attributes received from multiple ingress sources.

12. The method of claim 1, wherein attributes from ingress sources associated with multiple operational jurisdictions are correlated to construct the unified incident profile.

13. A centralized data clearinghouse system comprising:
one or more processors;
non-transitory memory storing a canonical internal schema; and
one or more network interfaces configured to receive heterogeneous incident data from multiple ingress sources;
wherein the one or more processors are configured to:
transform the heterogeneous incident data into protocol-independent structured representations conforming to the canonical internal schema stored in the non-transitory memory;
correlate attributes across the multiple ingress sources associated with a common incident to construct a unified incident profile represented in the canonical internal schema and independent of any individual ingress protocol;
perform the correlating once to generate the unified incident profile prior to distribution to multiple downstream systems;
distribute enriched structured outputs through a shared integration layer that abstracts direct bilateral source-to-destination integrations between the ingress sources and the downstream systems; and
update predictive machine-learning models using operational outcome feedback.

14. The system of claim 13, wherein the centralized data clearinghouse system is implemented across multiple distributed processing nodes operating as a coordinated logical processing layer.

15. A non-transitory computer-readable medium storing instructions that cause one or more processors to perform the method of claim 1.
